(19) United States
(12) Patent Application Publication
(10) Pub. No.: US 2003/0188608 A1
(43) Pub. Date: Oct. 9, 2003

(54) Handle structure for hand tools

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/426,795

(22) Filed: May 1, 2003

Related U.S. Application Data
(63) Continuation-in-part of application No. 10/118,172, filed on Apr. 9, 2002.

(51) Int. Cl. B25B 23/16

(52) U.S. Cl. 81/177.8

(57) ABSTRACT

A hand tool includes a handle which has two opposite first surfaces and two second surfaces. A width of each of the first surfaces is larger than a width of the second surfaces. An engaging portion is pivotably connected to an end of the handle so that the user's hand may contact the first surfaces when rotating the handle of the tool.

### FIELD OF THE INVENTION

The application is a Continuation-In-Part application for applicant's former application of Ser. No. 10/118,172, filed on Apr. 9, 2002 with a title of “Orientation Adjustable Spanner”.

### BACKGROUND OF THE INVENTION

Conventional spanners are designed for engaging or disengaging screws or the like. FIGS. 1 to 3 show various types of prior art spanners. These prior art spanners have engaging portions for engaging with screw means and the handles of these spanners are a thin plate-like structure and is connected to the engaging portion. The handles generally include four surfaces, wherein two surfaces of the handle that are parallel to the plane of the engaging portion. It is to be noted that the width of the surfaces that are parallel with the surface of the engaging portion is much larger than the other two surfaces of the handle as shown. When operating the spanners, the users hold the handle with thumb pressing on the narrow surface so as to rotate the engaging portion about an axis of the screw which is clamped by the engaging portion and not shown. This makes the users feel not comfortable because the narrow area applies a large force to the users'hand.

FIG. 4 shows a rear tool that has a handle with its middle portion being twisted 90 degrees. This design cannot fully dissolve the prior art problems and the twisted portion is a weak spot of the tool. It takes a lot of manufacturing steps to for the twisted portion.

### SUMMARY OF THE INVENTION

In accordance with one aspect of the present invention, there is provided a hand tool comprising a handle with an engaging portion pivotably connected to an end of the handle. The handle has two opposite first surfaces and two second surfaces, wherein a width of each of the first surfaces is larger than a width of the second surfaces. Two lugs extend from the end of the handle and the engaging portion has a protrusion which is pivotably connected between the two lugs by a pin extending through the two lugs and the protrusion.

The present invention intends to provide a hand tool that has a handle which has wider surfaces for the users to grasp so that when rotating the handle of the tool, the user's fingers and pawl contact the wider surfaces so that a smaller force is applied to the fingers and pawl.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIGS. 1 to 3 show three conventional hand tools;

FIG. 4 shows another conventional hand tool that has a twisted portion at the handle thereof;

FIG. 5 is a perspective view to show the hand tool of the present invention;

FIG. 6 is an exploded view to show the engaging portion and the handle;

FIG. 7 is a side view to show the hand tool of the present invention;

FIG. 8 shows the user's hand grasping the handle of the hand tool of the present invention;

FIG. 9 is a perspective view to show another embodiment of the hand tool of the present invention;

FIG. 10 shows yet another embodiment of the hand tool of the present invention;

FIG. 11 shows different connection of the engaging portion and the handle regarding to the hand tool shown in FIG. 10;

FIG. 12 shows a further another embodiment of the hand tool of the present invention, and

FIG. 13 shows different connection of the engaging portion and the handle regarding to the hand tool shown in FIG. 12.

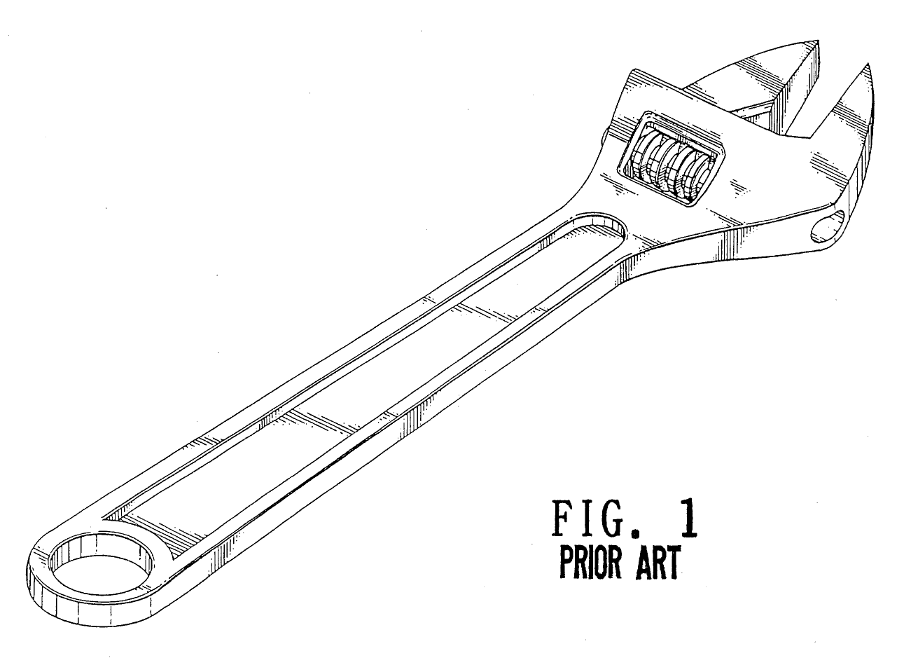

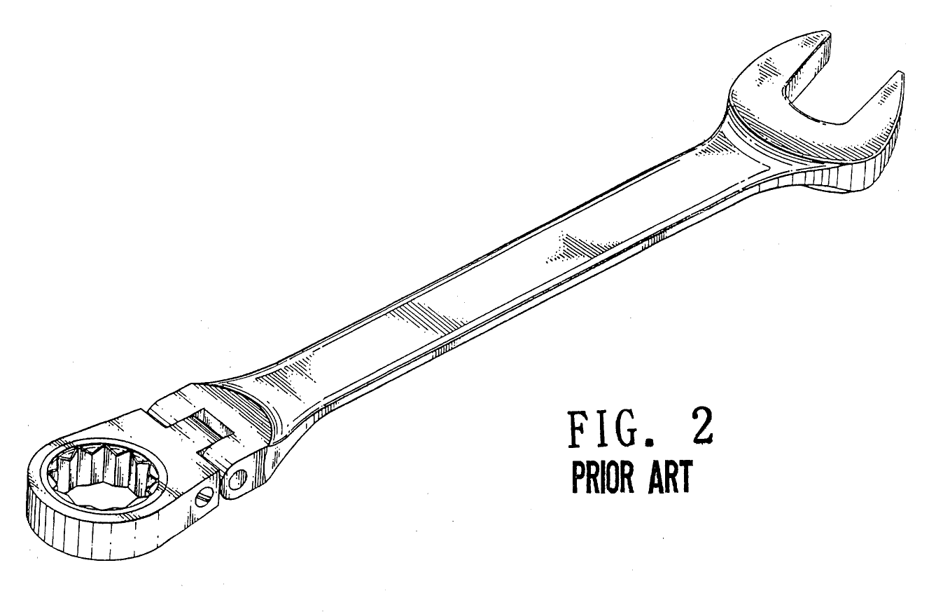

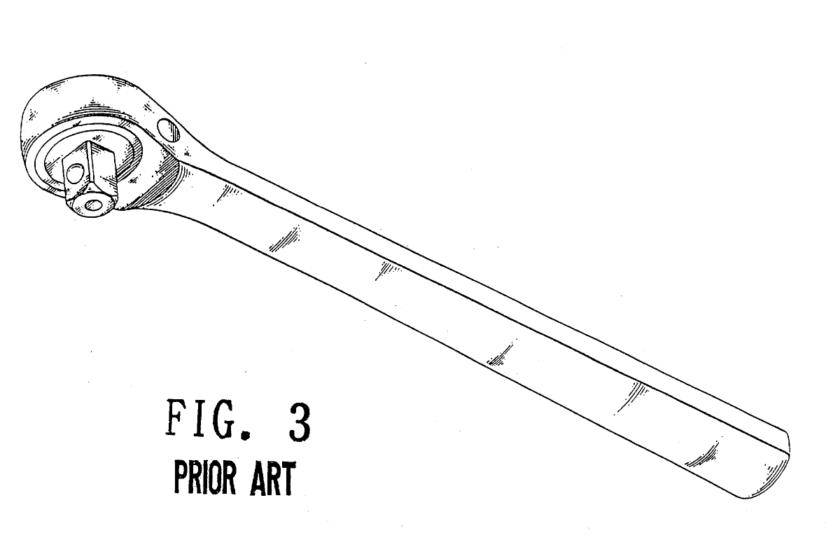

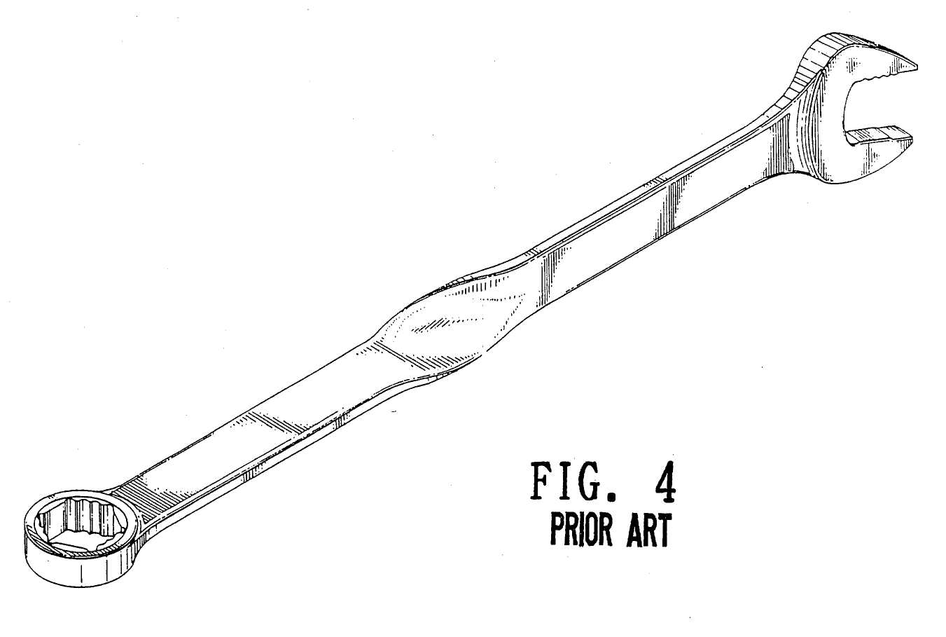

### DETAILED DESCRIPTION OF THE PREFERRED EMBODIMENT

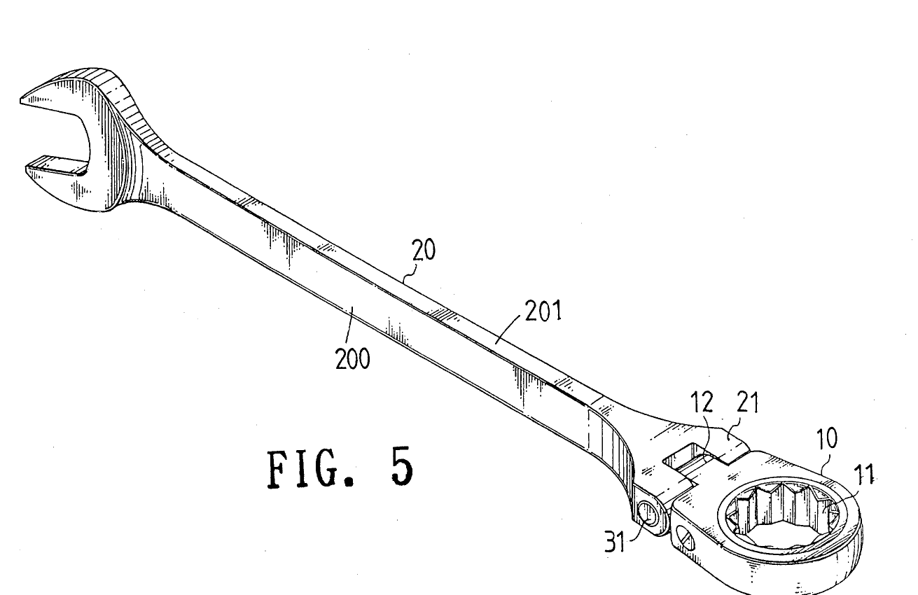

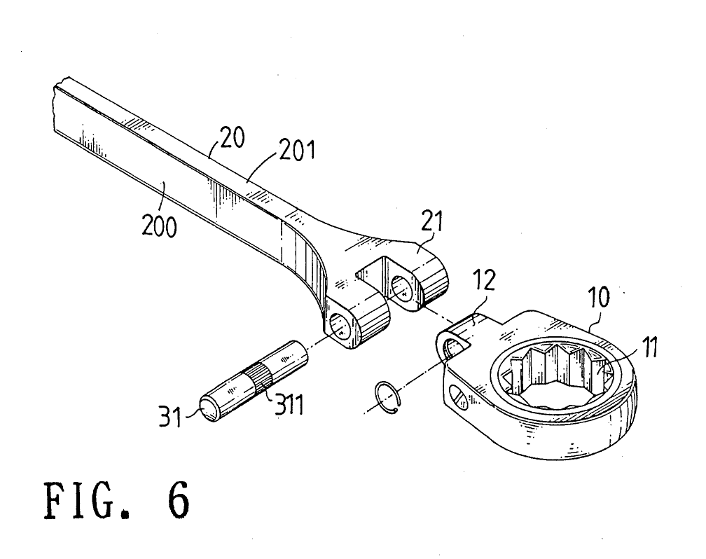

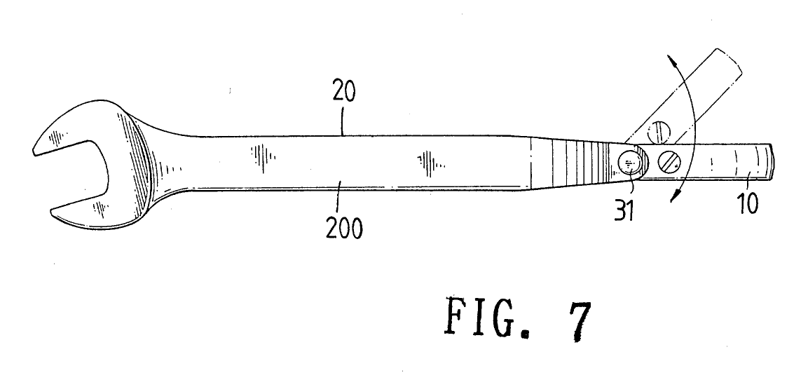

Referring to FIGS. 5 to 8, the hand tool of the present invention comprises a handle 20 having two opposite first surfaces 200 and two second surfaces 201. A width of each of the first surfaces 200 is larger than a width of the second surfaces 210. Two lugs 21 extend from an end of the handle 20 and an engaging portion 10 has a protrusion 12 which is pivotably connected between the two lugs 21 by a pin 31 extending through the two lugs 21 and the protrusion 12. The pin 31 includes a knurled section 311 which is engaged with an inner periphery of a passage defined through the protrusion 12 so as to conveniently position the engaging portion 10 relative to the handle 20. The engaging portion 10 includes a polygonal hole 11 defined therethrough so as to engage with a nut or the like which is not shown.

When a user holds the handle 20 of the hand tool and rotates the handle 20, the first surfaces 200 provide a larger contact area such that the hand feel comfortable because less pressure due to the larger contact surfaces.

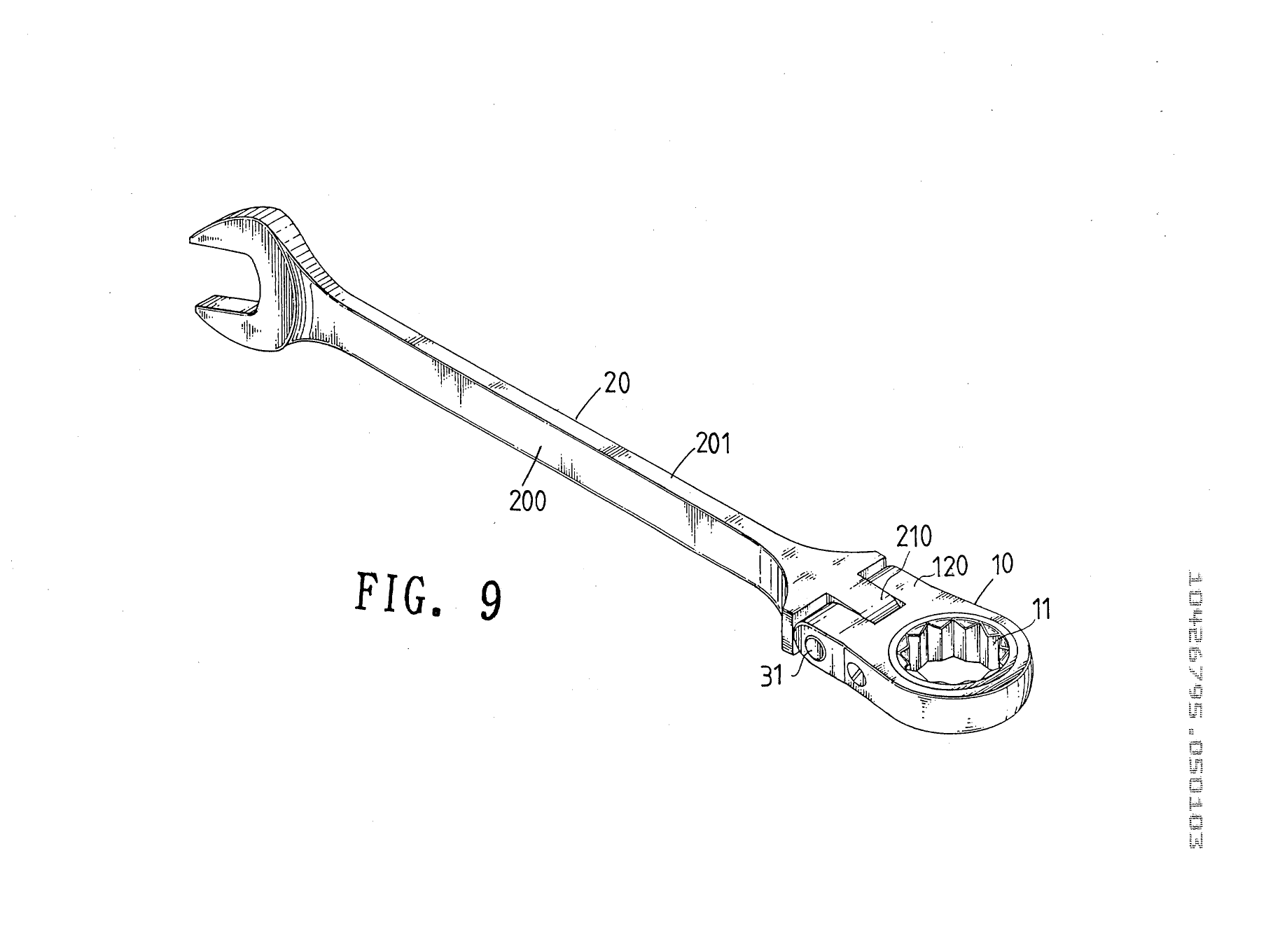

FIG. 9 shows another embodiment of the present invention wherein a connection portion 210 extends from an end of the handle 20 and an engaging portion 10 has two lugs 120 between which the connection portion 210 is pivotably connected by a pin 31 extending through the two lugs 120 and the connection portion 210.

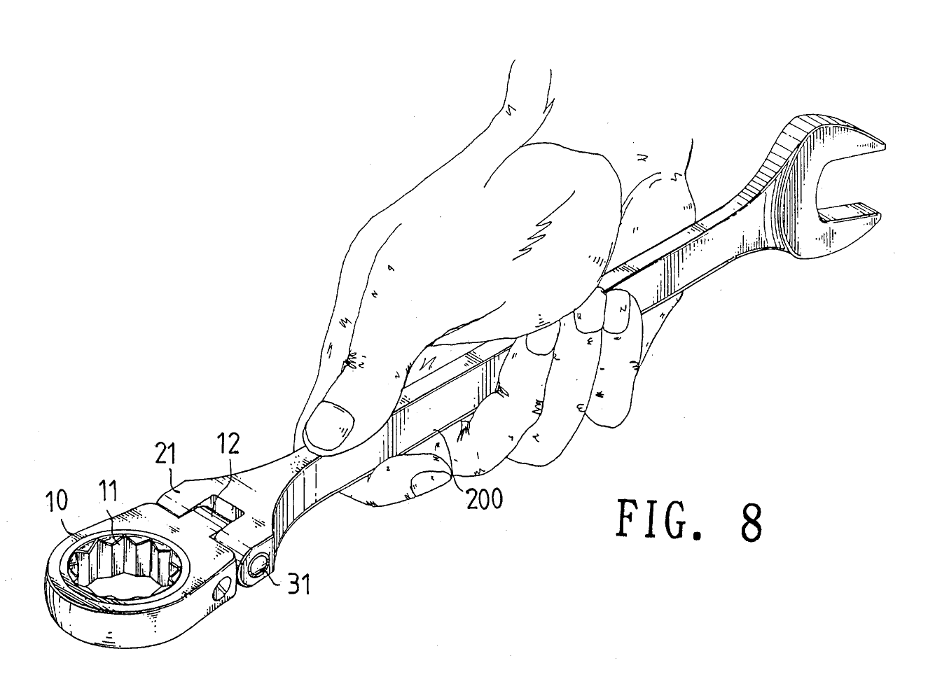

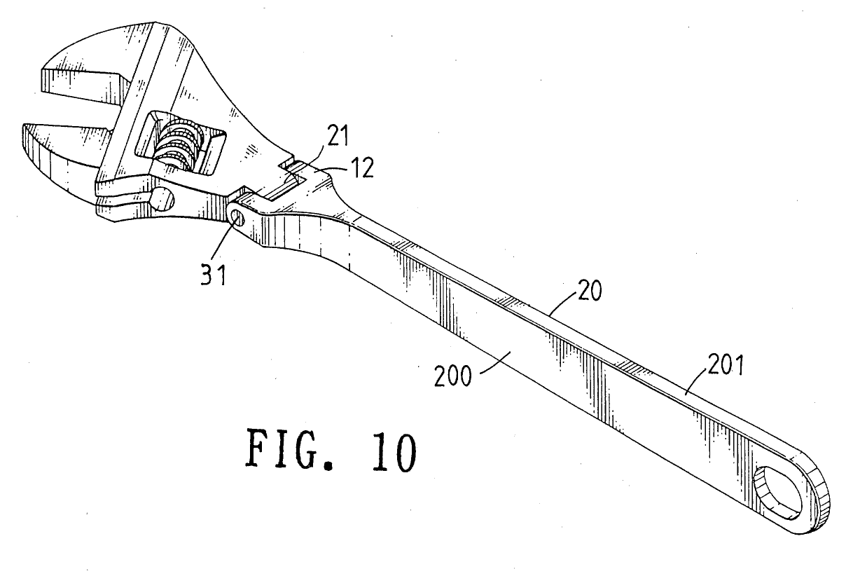

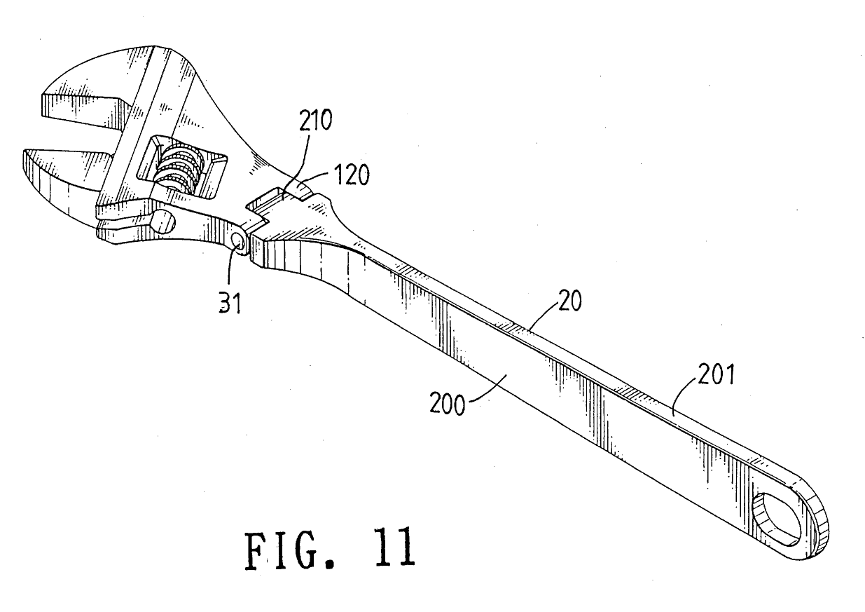

FIGS. 10 and 11 show that the engaging portion can be an adjustable spanner head and the connection between the handle 20 and the engaging portion are the same as those disclosed in FIGS. 8 and 9.

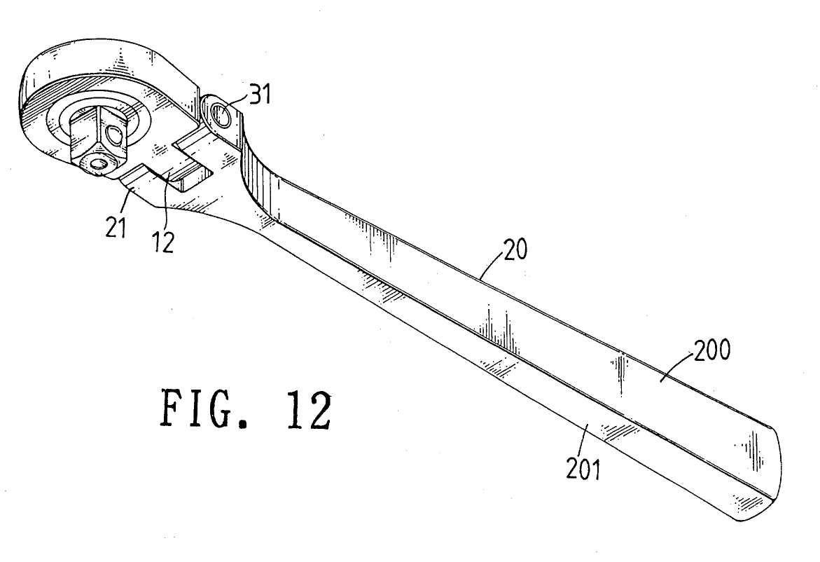

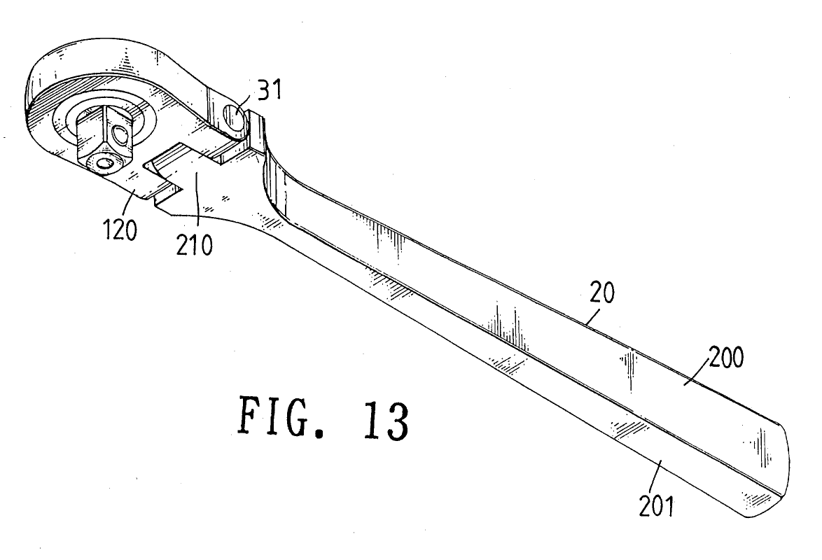

FIGS. 12 and 13 show that the engaging portion can be a ratchet driving means and the connection between the handle 20 and the ratchet driving means are the same as those disclosed in FIGS. 8 and 9.

While we have shown and described the embodiment in accordance with the present invention, it should be clear to those skilled in the art that further embodiments may be made without departing from the scope of the present invention.

What is claimed is:

1. A hand tool comprising:
a handle having two opposite first surfaces and two second surfaces, a width of each of the first surfaces larger than a width of the second surfaces;
two lugs extending from an end of the handle, and
an engaging portion having a protrusion which is pivotably connected between the two lugs by a pin extending through the two lugs and the protrusion.

2. The hand tool as claimed in claim 1, wherein the engaging portion includes a polygonal hole defined therethrough.

3. A hand tool comprising:
a handle having two opposite first surfaces and two second surfaces, a width of each of the first surfaces larger than a width of the second surfaces;
a connection portion extending from an end of the handle, and
an engaging portion having two lugs and the connection portion pivotably connected between the two lugs by a pin extending through the two lugs and the connection portion.
